(19) United States
(12) Patent Application Publication
(10) Pub. No.: US 2026/0099166 A1
(43) Pub. Date: Apr. 9, 2026

(54) PEDAL DEVICE FOR A MOTOR VEHICLE

(71) Applicant: HELLA GMBH & CO. KGAA, Lippstadt (DE)

(72) Inventors: Bernd Dautzenberg, Lippstadt (DE); Olaf Husberg, Warburg (DE); Ali Kemal Kücükyavuz, Bielefeld (DE); Ralf Ridder, Lippstadt (DE); Marc Seiffert, Lippstadt (DE); Claus Viethen, Erwitte (DE)

(21) Appl. No.: 19/351,768

(22) Filed: Oct. 7, 2025

(30) Foreign Application Priority Data
Oct. 8, 2024 (DE) 102024128914.7

(51) Int. Cl. G05G 5/05; B60T 7/04; G05G 1/38; G05G 1/42; G05G 5/03

(52) U.S. Cl. CPC G05G 5/05; B60T 7/042; G05G 1/38; G05G 1/42; G05G 5/03; B60T 2270/82; G05G 2505/00

(57) ABSTRACT

A pedal device for a motor vehicle is provided. The pedal device includes: a support structure; a pedal unit which can be displaced in translation in an actuating direction when loaded by a person with an actuating force; and a bearing unit by means of which the pedal unit is mounted on the support structure so as to be displaceable in translation. The bearing unit includes at least one return element which is configured to generate a counterforce opposing the actuating direction when the pedal unit is displaced in translation in the actuating direction, wherein the bearing unit has a scissor mechanism.

### CROSS-REFERENCE TO RELATED APPLICATIONS

The present application claims the benefit of German Patent Application No. 10-2024-128-914.7, filed Oct. 8, 2024, the disclosure of which is incorporated by reference.

### BACKGROUND OF THE INVENTION

The invention relates to a pedal device for a motor vehicle, having a support structure, a pedal unit which, when loaded by a person with an actuating force, can be displaced translationally in an actuating direction, and a bearing unit by means of which the pedal unit is mounted on the support structure such that it can be displaced translationally, the bearing unit having at least one return element which is designed to generate a counterforce opposing the actuating direction when the pedal unit is displaced translationally in the actuating direction.

Such pedal devices are generally known from the prior art, for example, in connection with braking systems. In braking systems, a basic distinction is made as to whether there is a mechanical connection between the pedal unit and a braking device.

In braking systems in which there is a mechanical connection between the pedal unit and the braking device, the displacement of the pedal unit directly triggers actuation of the braking device due to the mechanical coupling to the braking device, for example, in a hydraulic braking device, the hydraulic medium is loaded by a movement of the pedal unit, which in turn acts on the brake pads of the braking device and thereby moves the brake pads in the direction of the brake disk and presses them against the brake disk.

In so-called brake-by-wire braking systems, there is no mechanical coupling between the pedal device and the braking device, such as a hydraulic or electromechanical braking device. The displacement of the pedal unit is detected by a sensor, and the braking device is activated by a control unit based on this. In the present case, the pedal device should not be limited to a brake system, so that the pedal device can also form an accelerator pedal, for example. This means that the pedal device can be used for any X-by-wire application.

The pedal devices differ in the type of movement that the pedal units perform when a load is applied or when they are displaced. The pedal unit may be pivotably mounted on a support structure, whereby the pedal unit performs a pivoting movement about a pivot axis when loaded by the driver. On the other hand, the pedal unit may be mounted on a support structure in such a way that the pedal unit is translationally displaced in the direction of actuation when the pedal unit is loaded by the driver, and thus executes a linear movement in the actuating direction.

A disadvantage of the known pedal devices is that they usually require a large installation space due to the usually high pedal travel required, have a relatively high weight, are less comfortable to operate due to the relatively high pedal travel, and pose a risk of injury in the event of a crash due to the pedal unit protruding relatively far into the leg area of the driver.

### SUMMARY OF THE INVENTION

The object of the invention is therefore to provide a pedal device for a motor vehicle which has a relatively small installation space, is lightweight, increases operating comfort, and reduces the risk of injury in the event of a crash. This object is achieved by the features of the embodiments disclosed herein.

According to the invention, the bearing unit has a scissor mechanism with a first element and a second element, wherein the elements are each rotatably mounted at one end on the support structure and rotatably mounted at another end on the pedal unit, wherein the elements are additionally translationally displaceably mounted at one of the two ends on the pedal unit or on the support structure, and wherein the two elements are rotatably connected to one another in an intersecting region about an axis of rotation.

Such an embodiment of the pedal device provides a particularly reliable and stable mounting or attachment of the pedal unit to the support structure, whereby an actuating force can be applied at any point of the pedal unit without causing tilting or any other undesirable influence when the pedal unit is displaced in the actuating direction. During the translational displacement of the pedal unit, both elements pivot about a pivot axis of the respective bearing point on the support structure and about a pivot axis of the respective bearing point on the bearing unit being displaced. In addition, the elements are each translationally displaced at one of the bearing points on the pedal unit or on the support structure, in particular, transversely to the actuating direction. The rotatable mounting of the elements is generally achieved by means of a respective recess on the bearing unit or on the support structure for each element, into which a respective projection of the elements engages, wherein the recess at the bearing point at which the elements are also translationally displaceable relative to the pedal unit or to the support structure being designed as an elongated hole. During the displacement of the elements, the two elements are supported against each other, since the two elements are rotatably connected to each other in the intersecting area.

The elements are manufactured in one piece and made of plastic. In particular, the elements are manufactured by injection molding and have an essentially constant, relatively thin wall thickness. The elements have a stiffening structure to provide sufficient rigidity. In this way, the weight of the pedal device can be reduced. The pedal unit and the support structure are also made of plastic and have corresponding stiffening structures. The pedal unit can have a one-piece support structure and a pedal plate, wherein the pedal plate is attached, in particular, screwed or latched, to the support structure on a side opposite the scissor mechanism. The elements are mounted on the support structure. The support structure is preferably a housing which, together with the pedal unit, delimits an interior space in which the bearing unit or the scissor mechanism is arranged. The support structure or the housing is manufactured in one piece. Preferably, the pedal unit and the housing are cup-shaped, wherein the cup-shaped pedal unit and the cup-shaped housing are arranged with the open sides facing each other, and the pedal unit encompasses the housing. In other words, the pedal unit encompasses a collar of the housing with a collar. This provides a labyrinth seal, which prevents coarse dirt from entering the interior space.

The pedal unit has a plate-like actuating surface on which the driver can exert the actuating force. Due to the scissor mechanism, the pedal travel performed by the pedal unit is relatively short, in particular, a maximum of 15 mm.

In this way, a pedal device for a motor vehicle can be provided which has a relatively small installation space, is lightweight, increases operating comfort, and reduces the risk of injury in the event of a crash.

Preferably, the return element is arranged between the two elements and is supported by the elements. The return element is a spring element, in particular a compression spring designed as a spiral spring, wherein the distance between the elements is reduced as the pedal unit is displaced in the actuating direction, whereby the return element or the spring element is compressed. As soon as the actuating force is no longer present, the return element pushes the elements apart again, thereby increasing the distance between the elements and returning the pedal unit to its initial position. In the initial position, the pedal unit rests against a stop provided on the support structure. For this purpose, the pedal unit is preferably designed in such a way that a projection of the pedal unit projects through an opening in the support structure provided for this purpose, wherein the projection has a cross-sectional widening at the free end which is larger than the diameter of the opening. In the initial position, i.e. with a pedal travel equal to zero, the pedal unit strikes the support structure with the section with the widened cross-section counter to the actuating direction. In order to mount the pedal unit on the support structure, the pedal unit and/or the support structure are designed in several parts. In particular, a separate stop component is provided, which has a cross-sectional enlargement, wherein this stop component is attached, in particular screwed, to the support structure of the pedal unit. Alternatively, the return element may also be arranged between one of the elements and the support structure, wherein the distance between the element and the section of the support structure arranged below the element is reduced when the pedal unit is displaced in the actuating direction and the return element is compressed. When the pedal unit is released, the return element pushes the element and the pedal unit back to the initial position.

In a preferred embodiment, the bearing unit has two return elements, wherein a first return element is arranged on a first side between the two elements in relation to the axis of rotation, and a second return element is arranged on a second side, opposite to the first, between the two elements. As a result, the elements are loaded evenly by the return elements.

Preferably, the elements are mounted at both axial ends on the pedal unit and on the support structure. For this purpose, the pedal unit and the support structure each have two openings per element, arranged on a common axis, into which an element engages with two axially opposite ends. This can increase or improve the stability and therefore the feel of the pedal unit when operated by a rider's foot.

In a preferred embodiment, a respective separate bearing bolt is mounted on each of the elements for rotatable mounting on the pedal unit and/or on the support structure. The bearing bolts form an advantageous friction pairing with the pedal unit and the support structure. In particular, there is a low coefficient of friction between the bearing bolts and the pedal unit or support structure. The bearing bolts are preferably made of metal. In particular, the bearing bolts are screwed into the elements, i.e. into the threaded holes provided for this purpose in the elements. These have a tool engagement contour for mounting the bearing bolts.

Preferably, one of the elements has an opening through which the other element runs. This makes it possible to cross the elements, which in particular extend over almost the entire width, i.e. over the entire axial extension, of the pedal device. In a preferred embodiment, one of the elements has a bearing projection and the other element has a bearing opening. The bearing opening or the bearing projection is formed in the area of the opening through which one element passes through the other element, so that the elements are rotatably connected to each other in the area of the opening and thus in the crossing area of the elements. To mount such a scissor mechanism, the bearing opening is open radially outwards in a predefined region, so that the bearing projection can be inserted into the bearing opening during assembly.

Preferably, a sensor unit is provided which is designed to detect an actuating path in the actuating direction. The sensor unit is operatively connected to the pedal unit. The sensor unit is connected to a control unit in terms of signals, wherein the sensor signals are used to actuate a braking device. The pedal device, the control unit and the braking device thus form a brake-by-wire braking system. In principle, the pedal device, the control unit and another device may form any X-by-wire system.

In a preferred embodiment, the sensor unit has an angular position sensor, wherein a sensor element is operatively connected to the pedal unit via an extension arm, wherein the angular position sensor is designed such that a rotation of the sensor element about a sensor rotation axis due to a translational displacement of the pedal unit is detected, and the translational pedal travel is determined from the detected rotation. The sensor unit is preferably designed as an inductive sensor unit.

Preferably, the sensor element is loaded by a pretensioning element in such a way that the extension arm is pressed against the pedal unit. This provides a backlash-free coupling between the pedal unit and the sensor element, allowing the pedal travel of the pedal unit to be reliably determined or detected.

Another possible solution to the above-mentioned object is a vehicle, in particular an electrically powered vehicle with a pedal unit as described here.

### BRIEF DESCRIPTION OF THE DRAWINGS

The invention is explained in more detail hereafter with reference to the accompanying drawings. In the figures:

FIG. 1 is a perspective view of a pedal device;

FIG. 2 is a longitudinal section of the pedal device shown in FIG. 1;

FIG. 3 is a cross-section of the pedal device shown in FIG. 1; and

FIG. 4 is a perspective view of a scissor mechanism of the pedal device shown in FIG. 1.

### DETAILED DESCRIPTION OF THE CURRENT EMBODIMENTS

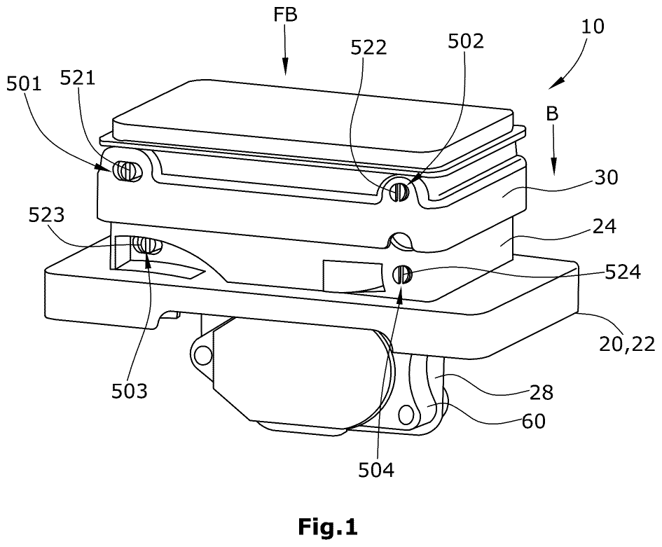

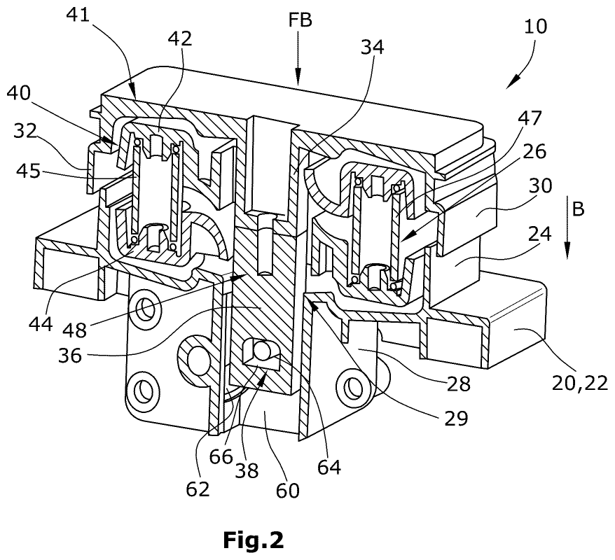

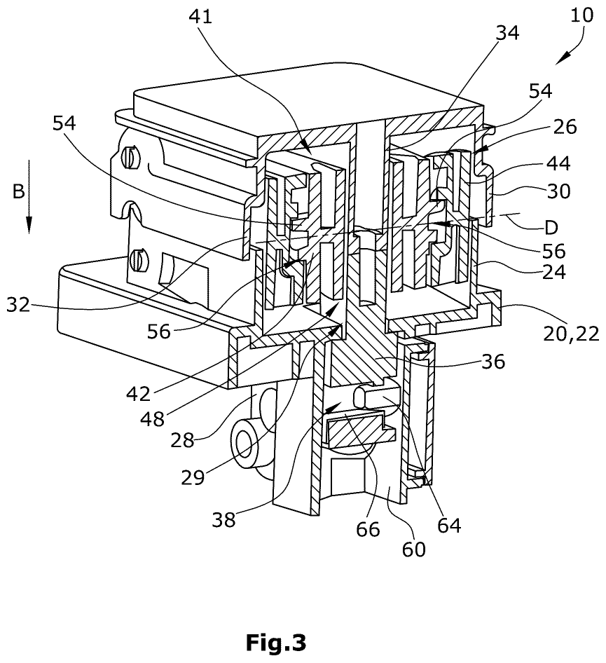

FIGS. 1, 2 and 3 show a pedal device 10 for a so-called brake-by-wire braking system of a motor vehicle, in which there is no mechanical coupling between the pedal device 10 and a braking device (not shown), for example, a hydraulic or electromechanical braking device. Here, the actuation of the pedal device 10 by a driver is detected and, based on this, the braking device is actuated by a control unit. The pedal device 10 can be used for any arbitrary X-by-wire application.

The pedal device 10 comprises a support structure 20, a pedal unit 30, and a sensor unit 60, wherein the pedal unit 30 is mounted on the support structure 20 so as to be displaceable in translation, and the sensor unit 60 is attached to the support structure 20.

The support structure 20 is designed as a housing 22, wherein the pedal device 10 can be mounted via the support structure 20 or the housing 22 on another component of the motor vehicle in the foot area of the driver's side. The housing 22 is manufactured in one piece and made of plastic. On a side facing the pedal unit 30, the housing 20 has a circumferential collar 24 which, together with the cup-shaped pedal unit 30, defines an interior space 26. On a side facing away from the pedal unit 30, the housing 22 has a fastening portion 28, to which the sensor unit 60 is fastened by screws (not shown). The housing 22 has a substantially constant wall thickness, wherein the required rigidity of the housing 22 is provided by stiffening means.

The pedal unit 30 is also made of plastic and, as already explained, is cup-shaped, such that the pedal unit 30 also has a collar 32 which encompasses the collar 24 of the housing 22, thereby creating a labyrinth seal to prevent the ingress of coarse dirt into the interior space 26. The pedal unit 30 has an essentially constant wall thickness and a stiffening structure. A cover element (not shown in the figures) is also arranged on the pedal unit 30, which is arranged on the side of the pedal unit 30 facing away from the housing 22 and is fixedly connected, in particular screwed, to the pedal unit 30. The pedal unit 30 has a projection 34 extending into the interior space 26, to which a stop component 36 is attached within the interior space 26. The stop component 36 protrudes from the interior space 26 through an opening 29 formed on the housing 22 and has a widened cross-section on this section protruding from the interior space 26. The widened cross-section is designed in such a way that it is larger in at least one spatial direction than the cross-section of the opening 29. As a result, the stop component 36, in an initial position, i.e. in a maximally extended state of the pedal unit 30, rests against a region of the housing 22 surrounding the opening 29 and thus strikes against the housing 22.

The stop component 36 also serves to couple the pedal unit to the sensor unit 60. For this purpose, the stop component 36 has an opening 38 in which the sensor device 60 engages in such a way that a translational movement of the pedal unit 30 can be detected by the sensor device 60.

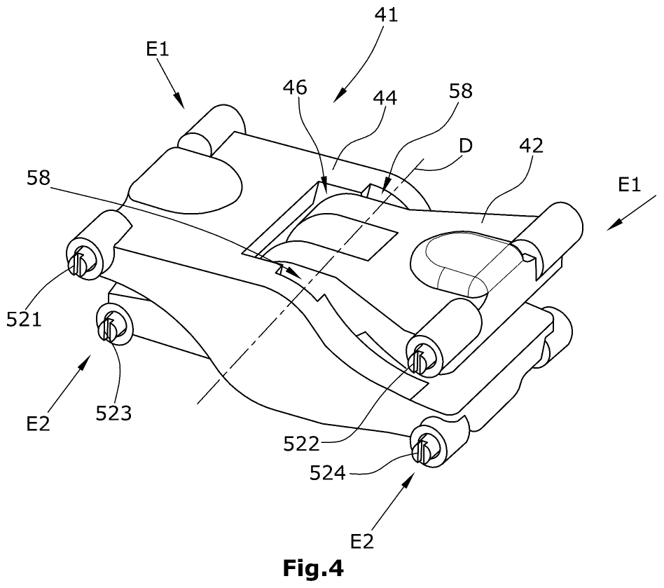

The pedal unit 30 is mounted on the support structure 20 or on the housing 22 by a bearing unit 40, which is arranged in the interior space 26 and is designed as a scissor mechanism, which is shown in FIG. 4. The bearing unit 40 has a first element 42 and a second element 44, which are arranged crosswise. For this purpose, the second element 44 has an opening 46 through which the first element 42 extends. The first element 42 also has an opening 48, with the projection 34 of the pedal unit 30 and the stop component 36 extending through the two openings 46, 48. Each element 42, 44 is rotatably connected on both sides in the axial direction with a first end E1 to the pedal unit 30 and with a second end E2 to the housing 22. In addition, the first end E1 of the second element 44 is mounted on the pedal unit 30, and the second end E2 of the first element 42 is mounted on the housing 22 such that it can be displaced in translation. For the mounting of the elements 42, 44, the pedal unit 30 and the housing 22 have a plurality of bearing openings 501, 502, 503, 504 on each side of the respective collar 24, 32, wherein only one of the two sides is shown in the figures. The bearing openings 501, 503, at which the elements 42, 44 are also mounted on the pedal unit 30 and on the housing 22 so that they can be displaced in translation, are not circular like the bearing openings 502, 504, but are elongated. A bearing bolt 521, 522, 523, 524 is provided at each bearing point on the elements 42, 44 for mounting on the pedal unit 30 and on the housing 22, which are each connected to the elements 42, 44 by a respective screw connection.

The elements 42, 44 are rotatably connected to each other in the intersecting region, i.e. in the region of the opening 46, so that they can rotate about an axis of rotation D. For this purpose, the first element 42 has a bearing projection 54 on both sides in the axial direction, and the second element 44 has a bearing opening 56 for each bearing projection 54, the bearing projections 54 engaging in the bearing openings 56 in the final assembled state. For mounting the elements 42, 44 together, the bearing openings 56 are radially open in a predefined region 58, so that the bearing projections 54 can be inserted into the bearing openings 56 via the regions 58 during mounting.

In order to displace the pedal unit 30 into an initial position, i.e. into a position in which no actuating force FB applied by a driver acts on the pedal unit 30, the pedal device 10 has two return elements 45, 47, in particular designed as compression springs, wherein a first return element 45 being arranged on a first side between the two elements 42, 44 with respect to the axis of rotation D and a second return element 47 being arranged on a second side, opposite to the first side, between the two elements 42, 44. In the initial position of the pedal unit 30, the return elements 45, 47 press the stop component 36 with the section at which the cross-sectional widening is present against the housing 22.

The sensor unit 60 has an inductive angular position sensor 61 and a sensor element 62 with an extension arm 64, the sensor element 62 engaging with the extension arm 64 in the opening 38. A pretensioning element 66 is arranged in the opening 38, which is designed as a spring element and presses the extension arm 64 engaging in the opening 36 against the circumferential surface of the opening 38.

When the pedal unit 30 is actuated, i.e. when the pedal unit 30 is loaded with an actuating force FB in actuating direction B, the pedal unit 30 is displaced in the actuating direction B starting from an initial position. As a result, both elements 42, 44 pivot about a respective pivot axis of each bearing opening 501, 502, 503, 504 on the housing 22 and on the pedal unit 30. In addition, the elements 42, 44 move translationally at the bearing openings 501, 503 and rotate relative to each other about the axis of rotation D. As the pedal unit 30 is displaced in the actuating direction B, the distance between the elements 42, 44 decreases, whereby the return elements 45, 47 are pressed together. As soon as the actuating force FB is no longer present, the return elements 45, 47 push the elements 42, 44 apart again, whereby the distance between the elements 42, 44 increases again, and the pedal unit 30 is moved back to the initial position. During the displacement of the pedal unit 30, the sensor element 62 is rotated due to the coupling with the stop component 36, and thus the pedal travel is determined, wherein the sensor signal of the sensor unit 60 is transmitted to the control unit, which actuates the braking device based on it.

### LIST OF REFERENCE SYMBOLS

10 braking device
20 support structure
22 housing
24 collar
26 interior space
28 fastening portion
30 pedal unit
32 collar
34 projection
36 stop component
38 opening
40 bearing unit
41 scissor mechanism
42 first element
44 second element
45 first return element
46 opening
47 second return element
48 opening
501 bearing opening
502 bearing opening
503 bearing opening
504 bearing opening
521 bearing bolt
522 bearing bolt
523 bearing bolt
524 bearing bolt
54 bearing projection
56 bearing opening
58 predefined region
60 sensor unit
61 angular position sensor
62 sensor element
64 extension arm
66 pretensioning element
D axis of rotation
B actuating direction
FB actuating force
E1 first end
E2 second end

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A pedal device for a motor vehicle, comprising:
a support structure;
a pedal unit, the pedal unit being displaceable in translation in an actuating direction when loaded by a person with an actuating force;
a bearing unit, the pedal unit being mounted to the support structure via the bearing unit, the bearing unit having at least one return element which is configured to generate a counterforce opposing the actuating direction when the pedal unit is displaced in translation in the actuating direction, the bearing unit having a scissor mechanism with a first element and a second element, the first and second elements each being rotatably mounted at a first end to the support structure and being rotatably mounted at a second end to the pedal unit, wherein the first and second elements are additionally mounted to the support structure or the pedal unit to as to be displaceable in translation, wherein the first and second elements are connected to one another to be rotatable about an axis of rotation in an intersecting region.

2. The pedal device of claim 1, wherein the at least one return element is disposed between the first and second elements and is supported on the first and second elements.

3. The pedal device of claim 2, wherein the at least one return element includes a first return element and a second return element, the first return element being disposed on a first side between the first and second elements with respect to the axis of rotation, the second return element being disposed on a second side between the first and second elements.

4. The pedal device of claim 1, wherein the first and second elements are mounted at both axial ends to the pedal unit and to the support structure.

5. The pedal device of claim 1, wherein the bearing unit is configured such that the pedal unit is displaceable with a maximum pedal travel of 15 mm in the actuating direction.

6. The pedal device of claim 1, wherein:
the first element is rotatably mounted to the pedal unit or the support structure via a first bearing bolt that engages a first opening of the pedal unit or the support structure; and
the second element is rotatably mounted to the pedal unit or the support structure via a second bearing bolt that engages a second opening of the pedal unit or the support structure.

7. The pedal device of claim 1, wherein the first element has an opening through which the second element extends.

8. The pedal device of claim 1, wherein the first element has a bearing projection and the second element has a bearing opening.

9. The pedal device of claim 8, wherein the bearing opening is open radially outwards in a predefined region such that the bearing projection can be inserted into the bearing opening during assembly.

10. The pedal device of claim 1, further comprising a sensor unit configured to detect pedal travel in the actuating direction.

11. The pedal device of claim 10, wherein the sensor unit includes:
an angular position sensor; and
a sensor element operatively connected to the pedal unit via an extension arm;
wherein the angular position sensor is configured such that rotation of the sensor element about a sensor rotation axis is detected as a result of a translational displacement of the pedal unit, and wherein the pedal travel is determined from the detected rotation of the sensor element.

12. The pedal device of claim 11, wherein the sensor element is loaded by a pretensioning element, such that the extension arm is pressed against the pedal unit.

13. The pedal device of claim 10, wherein the sensor unit includes an inductive sensor.

14. The pedal device of claim 1, wherein the support structure is a housing which delimits an interior space in which the bearing unit is arranged.

15. The pedal device of claim 14, wherein the pedal unit encompasses a collar of the housing with a circumferential collar.
